(19) United States
(12) Patent Application Publication
(10) Pub. No.: US 2007/0129951 A1
(43) Pub. Date: Jun. 7, 2007

(54) SYSTEM AND METHOD FOR TESTING A MOTHERBOARD AUDIO MODULE

(75) Inventor: Mo-Ying Tong, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,577

(22) Filed: Aug. 25, 2006

(30) Foreign Application Priority Data
Dec. 2, 2005 (CN) 200510101995.1

(51) Int. Cl. G10L 21/00

(52) U.S. Cl. 704/500

(57) ABSTRACT

A method for testing a motherboard audio module is provided. The method includes the steps of: setting an audio module (104) to be tested in a computer (100) to play an original audio file that includes a first audio signal, and outputting the first audio signal to an impedance matching device (106) connected to the computer; receiving the first audio signal outputted from the impedance matching device to the audio module, and outputting a second audio signal after the audio module processes the first audio signal; determining parameters of the first audio signal and parameters of the second audio signal; compensating errors of parameters of the first audio signal, and obtaining compensated parameters in response; and comparing parameters of the second audio signal with the compensated parameters to determine whether the parameters of the second audio signal exceed the compensated parameters. A related system is also provided.

### FIELD OF THE INVENTION

The present invention is generally related to systems and methods for testing a motherboard, and more particularly, to a system and method for testing a motherboard audio module.

### DESCRIPTION OF RELATED ART

Nowadays, a computer not only assists people in data processing, but it can also be used as a multimedia player that brings music or multimedia presentation to people. A motherboard audio module (thereinafter, “audio module”) plays an important role in transmitting audio signals within a computer. Typically, the audio module includes an analog to digital conversion circuit and a digital to analog conversion circuit, which are used for converting between analog signals and digital signals.

Before a motherboard is shipped to a customer or a motherboard reseller, the motherboard should pass a series of tests, such as performance test on transmitting signals of an audio module whereon, to make sure that the motherboard works normally. The performance parameters of the audio module, in general, include frequency offset, noise level, dynamic range, total harmonic distortion (THD) +noise, and intermodulation distortion. The test of the audio module is just a part of a series of motherboard tests, and due to a testing time limit, rarely does all the performance parameters of the above-mentioned are tested. The only two performance parameters that need to be tested are frequency response and noise level. A conventional solution to audio tests is to compare an original audio signal with a recorded audio signal that is obtained by connecting the input port of the audio module to its output port directly with a conductor.

This conventional solution has disadvantages. For example, the conductor, which connects the input port to the output port, can disturb the accuracy of test results due to resistance.

Accordingly, what is needed is a system and method for testing an audio module, which can lower the disturbance produced by the conductor which connects the input port to the output port, and enhance the accuracy in the course of the test.

### SUMMARY OF INVENTION

One preferred embodiment provides a system for testing a motherboard audio module which is to be tested in a computer to play an original audio that comprising a first audio signal. The system includes a signal outputting module, a signal analyzing module, a compensating module, and a determining module. The signal outputting module is configured for outputting the first audio signal to an impedance matching device connected to the computer, the impedance matching device transmitting the first audio signal back to the audio module, the audio module processing the first audio signal and outputting a second audio signal in response. The signal analyzing module is configured for determining parameters of the first audio signal and parameters of the second audio signal. The compensating module is configured for compensating errors of parameters of the first audio signal, and obtaining compensated parameters in response. The comparing module is configured for comparing parameters of the second audio signal with the compensated parameters to determine whether the parameters of the second audio signal exceed the compensated parameters.

Another preferred embodiment provides a computer-based method for testing a motherboard audio module. The method includes the steps of: setting an audio module to be tested in a computer to play an original audio file that includes a first audio signal, and outputting the first audio signal to an impedance matching device connected to the computer; receiving the first audio signal outputted from the impedance matching device to the audio module, and outputting a second audio signal after the audio module processes the first audio signal; determining parameters of the first audio signal and parameters of the second audio signal; compensating errors of parameters of the first audio signal, and obtaining compensated parameters in response; and comparing parameters of the second audio signal with the compensated parameters to determine whether the parameters of the second audio signal exceed the compensated parameters.

Other systems, methods, features, and advantages will be or become apparent to one skilled in the art upon examination of the following drawings and detailed description.

### BRIEF DESCRIPTION OF DRAWINGS

FIG. 1 is a schematic diagram of hardware configuration of a system for testing a motherboard audio module in accordance with one preferred embodiment;

FIG. 2 is a schematic diagram of function modules of an audio module test unit in FIG. 1; and

FIG. 3 is a flowchart of a method for testing a motherboard audio module in accordance with one preferred embodiment.

### DETAILED DESCRIPTION

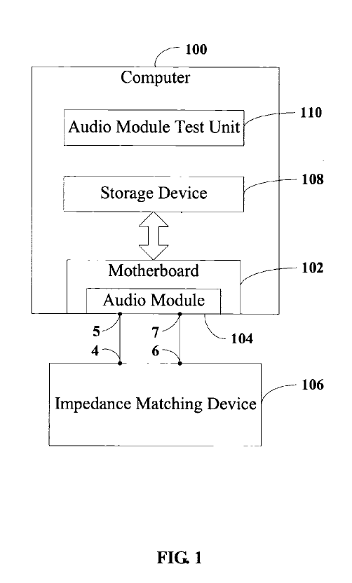

FIG. 1 is a schematic diagram of hardware configuration of a system for testing a motherboard audio module in accordance with one preferred embodiment. The hardware configuration may typically include a computer 100, and an impedance matching device 106 connected to the computer 100. The computer 100 may be an IBM architecture personal computer (PC), or any other type of computer. Typically, the computer 100 may includes a storing device 108, an audio module test unit 110, and a motherboard 102 having an audio module 104 therein. The computer 100 may further include other devices, such as a central processing unit (CPU), a memory, a monitor, a mouse, and a keyboard. The audio module 104 may include an input port 5 and an output port 7. The impedance matching device 106 may include an input port 4 associated to the input port 5, and an output port 6 associated to the output port 7. The audio module test unit 110 is configured for testing the audio module 104.

The motherboard 102 typically provides a plurality of interfaces or ports for an attachment of various peripheral devices or hardware, for example, providing a CPU socket for the attachment of a CPU and providing a memory slot for the attachment of a memory. Each hardware device connected to the computer 100 has a corresponding driver installed in the computer 100, through which an operating system (OS) that is installed in the computer 100, can communicate and manage the hardware device. In the preferred embodiment, the motherboard 102 further provides a storage interface for the attachment of the storage device 108, and an audio interface for the attachment of the audio module 104.

The audio module 104 includes an analog to digital converter (A/D) which is configured for converting analog signals into digital signals, a coder-decoder (CODEC) which is configured for converting signals into a format suitable for transmission, and a digital to analog converter (D/A) which is configured for converting digital signals into analog signals.

The impedance matching device 106, which is configured by inserting matching networks into a circuit between a source and a load, is an engineering procedure employed in circuit designs for matching unequal source and load impedances. The impedance matching device 106 is required in order to optimize the power delivered to the load from the source.

The storage device 108 may be an internal storage of the computer 100, such as a hard disk or a floppy disk, or even an external storage device, such as a compact disk, a flash memory or the like.

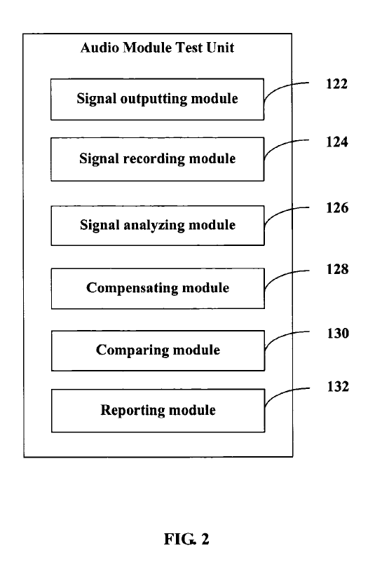

FIG. 2 is a schematic diagram of function modules of the audio module test unit 110. The audio module test unit 110 mainly includes a signal outputting module 122, a signal recording module 124, a signal analyzing module 126, a compensating module 128, a comparing module 130, and a reporting module 132.

The signal outputting module 122 is configured for setting the audio module 104 to play an original audio file that includes a first audio signal, and outputting the first audio signal to the impedance matching device 106. In the preferred embodiment, the original audio file is stored in the storing device 108, and the original audio file is in a wave formatted file. In alternative embodiments, the original audio file can also be in any other format, such as the musical instrument digital interface (MIDI) format, or the moving picture experts group audio layer III (MP3) format.

The impedance matching device 106 transmits the first audio signal back to the audio module 104. Then, the audio module 104 processes the first audio signal by the analog to digital converter (A/D), the coder-decoder (CODEC), and the digital to analog converter (D/A) therein, and outputs a second audio signal in response.

The signal recording module 124 is configured for receiving the second audio signal, and recording it as an output audio file to be stored in the storing device 108. Wherein, the output audio file is a wave formatted file. In alternative embodiments, the output audio file can also be in any other format, such as the MIDI format, or the MP3 format.

The signal analyzing module 126 is configured for pre-analyzing the first audio signal and the second audio signal by utilizing a window function in order to lower the frequency domains distortion caused by digital processing on finite-length sequences, changing the first audio signal and the second audio signal from time domains to frequency domains by using a fast fourier transform (FFT) algorithm, and determining parameters of the first audio signal and parameters of the second audio signal. Wherein, the time domain described above refers to a conversion of audio signals against time, and the frequency domain described above refers to a conversion of audio signals against a frequency. In the preferred embodiment, the parameters include a frequency offset and a noise level.

The compensating module 128 is configured for compensating errors of parameters of the first audio signal, and obtaining compensated parameters in response.

The comparing module 130 is configured for comparing parameters of the second audio signal with the compensated parameters to determine whether the parameters of the second audio signal exceed the compensated parameters.

The reporting module 132 is configured for reporting a test result according to the comparison result of the comparing module 130. Specifically, if the parameters of the second audio signal do not exceed the compensated parameters, the reporting module 132 reports a pass test result denoting that the audio module 104 is in good working condition. Otherwise, if the parameters of the second audio signal exceed the compensated parameters, the reporting module 132 reports a fail test result denoting that the audio module 104 is defective.

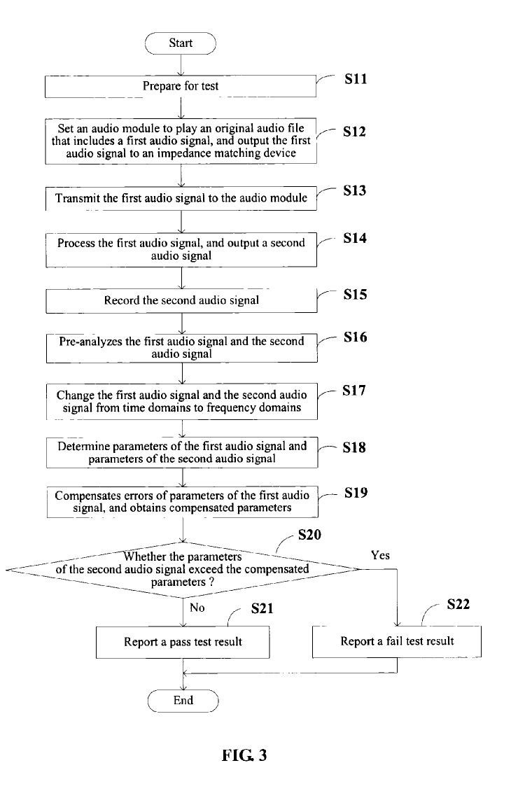

FIG. 3 is a flowchart of a method for testing a motherboard audio module in accordance with one preferred embodiment. In Step S11 the method and test preparations are setup that involves: connecting the input port 5 of the audio module 104 with the input port 4 of the impedance matching device 106, connecting the output port 7 of the audio module 104 with the output port 6 of the impedance matching device 106; preparing the original audio file in the storing device 108; initializing the audio module 104 and setting sample rate and data precision of the analog to digital converter (A/D) and the digital to analog converter (D/A). In the preferred embodiment, the sample rate is set as 44.1 kiloherz (kHz) and the data precision is set at 16 bits.

In step S12, the signal outputting module 122 sets the audio module 104 to play the original audio file includes a first audio signal, and outputs the first audio signal to the impedance matching device 106. Wherein, the original audio file is stored in the storing device 108.

In step S13, the impedance matching device 106 receives the first audio signal, and transmits the first audio signal back to the audio module 104.

In step S14, the audio module 104 receives the first audio signal, and outputs a second audio signal after processing the first audio signal via the analog to digital converter (A/D), the coder-decoder (CODEC), and the digital to analog converter (D/A) therein.

In step S15, the signal recording module 124 receives the second audio signal that is outputted by the audio module 104, and records the second audio signal as an output audio file to be stored on the storing device 108.

In step S16, the signal analyzing module 126 pre-analyzes the first audio signal and the second audio signal by multiplying a window function such as hanning( ), in order to lower the frequency domains distortion cause by digital processing on finite-length sequences.

In step S17, the signal analyzing module 126 changes the first audio signal and the second audio signal from time domains to frequency domains by using the FFT algorithm.

In step S18, the signal analyzing module 126 determines parameters of the first audio signal and parameters of the second audio signal.

In step S19, the compensating module 128 compensates errors of parameters of the first audio signal, and obtains compensated parameters in response.

In step S20, the comparing module 130 compares parameters of the second audio signal with the compensated parameters to determine whether the parameters of the second audio signal exceed the compensated parameters.

In step S21, if the parameters of the second audio signal do not exceed the compensated parameters, the audio module 104 passes the test, and the reporting module 132 reports a pass test result denoting that the audio module 104 is in good working condition. Otherwise, if the parameters of the second audio signal exceed the compensated parameters, in step S22, the audio module 104 fails the test, and the reporting module 132 reports a fail test result denoting that the audio module 104 is defective.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for testing a motherboard audio module which is to be tested in a computer to play an original audio that comprising a first audio signal, the system comprising:
a signal outputting module configured for outputting the first audio signal to an impedance matching device connected to the computer, the impedance matching device transmitting the first audio signal back to the audio module, the audio module processing the first audio signal and outputting a second audio signal in response;
a signal analyzing module configured for determining parameters of the first audio signal and parameters of the second audio signal;
a compensating module configured for compensating errors of parameters of the first audio signal, and obtaining compensated parameters in response; and
a comparing module configured for comparing parameters of the second audio signal with the compensated parameters to determine whether the parameters of the second audio signal exceed the compensated parameters.

2. The system according to claim 1, further comprising a signal recording module configured for recording the second audio signal as an output audio file.

3. The system according to claim 1, wherein the signal analyzing module is further configured for pre-analyzing the first audio signal and the second audio signal by utilizing a window function.

4. The system according to claim 1, wherein the signal analyzing module is further configured for changing the first audio signal and the second audio signal from time domains to frequency domains by using a fast fourier transform (FFT) algorithm.

5. The system according to claim 1, further comprising a reporting module for reporting a test result according to the comparison result of the comparing module.

6. The system according to claim 5, wherein the reporting module reports a pass test result denoting that the audio module is in good working condition if the parameters of the second audio signal do not exceed the compensated parameters, and reports a fail test result denoting that the audio module is defective if the parameters of the second audio signal exceed the compensated parameters.

7. The system according to claim 1, wherein the audio module comprises an analog to digital converter (A/D), a coder-decoder (CODEC), and a digital to analog converter (D/A).

8. The system according to claim 1, wherein the parameters include a frequency offset and a noise level.

9. A computer-based method for testing a motherboard audio module, the method comprising the steps of:
setting an audio module to be tested in a computer to play an original audio file that includes a first audio signal, and outputting the first audio signal to an impedance matching device connected to the computer;
receiving the first audio signal outputted from the impedance matching device to the audio module, and outputting a second audio signal after the audio module processes the first audio signal;
determining parameters of the first audio signal and parameters of the second audio signal; compensating errors of parameters of the first audio signal, and obtaining compensated parameters in response; and
comparing parameters of the second audio signal with the compensated parameters to determine whether the parameters of the second audio signal exceed the compensated parameters.

10. The method according to claim 9, further comprising the step of recording the second audio signal as an output audio file.

11. The method according to claim 9, further comprising the step of pre-analyzing the first audio signal and the second audio signal by utilizing a window function, and changing the first audio signal and the second audio signal from time domains to frequency domains by using a fast fourier transform (FFT) algorithm.

12. The method according to claim 9, further comprising the step of reporting a test result according to the comparison result.

13. The method according to claim 12, wherein the test result is a pass test result denoting that the audio module is in good working condition if the parameters of the second audio signal do not exceed the compensated parameters, and is a fail test result denoting that the audio module is defective if the parameters of the second audio signal exceed the compensated parameters.

14. The method according to claim 9, wherein the audio module comprises an analog to digital converter (A/D), a coder-decoder (CODEC), and a digital to analog converter (D/A).

15. The method according to claim 9, wherein the parameters include a frequency offset and a noise level.
